(19) United States
(12) Patent Application Publication
(10) Pub. No.: US 2018/0284548 A1
(43) Pub. Date: Oct. 4, 2018

(54) ARRAY SUBSTRATE, FABRICATING METHOD THEREOF, AND DISPLAY PANEL

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Xi XIANG, Beijing (CN); Ni JIANG, Beijing (CN); Yuanming FENG, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu, Sichuan (CN)

(21) Appl. No.: 15/758,078

(22) PCT Filed: Jun. 26, 2015
(86) PCT No.: PCT/CN2015/082469

§ 371 Date: Mar. 7, 2018

(30) Foreign Application Priority Data
Sep. 23, 2014 (CN) 201410490188.2

(51) Int. Cl. G02F 1/1343; G02F 1/1333

(52) U.S. Cl. CPC G02F 1/134363; G02F 1/133345; G02F 1/13439; G02F 2201/121; G02F 2001/134345; G02F 2201/123; G02F 2001/133357

(57) ABSTRACT

An array substrate, a fabricating method thereof, and a display panel including the array substrate are provided. The array substrate includes a base substrate (1), a planarization layer (12), and a first electrode layer (13). The planarization layer (12) in on the base substrate (1) and has a plurality of protrusions (20) protruding away from the base substrate (1) and resulting in a plurality of grooves between adjacent protrusions (20). The first electrode layer (13) has at least a portion over the plurality of protrusions (20) of planarization layer (12).

### CROSS-REFERENCES TO RELATED APPLICATIONS

This application claims the priority of Chinese patent application No. CN201410490188.2, filed on Sep. 23, 2014, the entire content of which is incorporated herein by reference.

### FIELD OF THE DISCLOSURE

The present disclosure generally relates to the field of display technologies and, more particularly, relates to an array substrate, a fabricating method thereof, and a display panel including an array substrate.

### BACKGROUND

To satisfy the consumer's needs for high quality display products, liquid crystal display (LCD) panels are demanded for higher resolutions, which often causes lower aperture ratio and higher power consumption.

FIG. 1 illustrates a schematic structure of a conventional array substrate. As shown, a planarization layer 2, a first electrode layer 3, an insulation layer 4, and a second electrode layer 5 may be formed sequentially on the base substrate 1. The base substrate 1 includes a thin film transistor array. The second electrode layer 5 may include a plurality of second sub-electrodes 50.

Liquid crystals 7 used in conventional high PPI (i.e., pixels per inch) display products are usually positive liquid crystals. As shown in FIG. 1, when a driving voltage is applied, positive liquid crystal molecules tend to be oriented in parallel along the electric field lines 6. In high PPI display products, it is desirable to arrange liquid crystal molecules in a direction parallel with the base substrate 1 to increase the light transmittance. However, when the electric field lines 6 are in vertical orientation, for example, in a center region of the sub-electrodes or in the middle of the gaps between adjacent sub-electrodes (e.g., as highlighted in FIG. 1 with the dotted lines), liquid crystal molecules are arranged in a direction perpendicular to the base substrate. The light transmittance in such regions is deteriorated with dark lines. Backlight intensity may have to be increased to maintain desirable brightness. Accordingly, power consumption is significantly increased.

In order to reduce power consumption and maintain a satisfactory brightness, one approach is to reduce the display panel driving voltage. Analysis indicates that by reducing thickness of the insulation layer 4, the electric field intensity between the first electrode layer 3 and the second electrode layer 5 may be increased and the driving voltage may be reduced. However, every 3000 Å reduction in thickness of the insulation layer 4 may allow about 0.5 V reduction in the driving voltage. In high PPI display products, the insulation layer 4 is already very thin. It's difficult to further reduce the driving voltage by reducing the thickness of the insulation layer.

Therefore, the disclosed structure, device, and method are directed to at least partially alleviate one or more of the problems set forth above and other problems existed in the art, in order to achieve high light transmittance at low power consumption.

### BRIEF SUMMARY OF THE DISCLOSURE

One aspect of the present disclosure provides an array substrate. The array substrate includes a base substrate, a planarization layer, and a first electrode layer. The planarization layer is on the base substrate and has a plurality of protrusions protruding away from the base substrate and resulting in a plurality of grooves between adjacent protrusions. The first electrode layer has at least a portion over the plurality of protrusions of planarization layer.

Optionally, an insulation layer at least partially fills each groove. A second electrode layer is over the insulation layer. Optionally, the protrusions and insulation layer are shaped such that the second electrode layer and the portion of the first electrode layer over the protrusions are of substantially a same height from the base substrate. Optionally, the second electrode layer includes a plurality of second sub-electrodes. Each second sub-electrode is in the groove between the adjacent protrusions and electrically insulated from the first electrode layer.

The insulation layer is between the first electrode layer and the second electrode layer. Optionally, each second sub-electrode is stripe-shaped, and the plurality of second sub-electrodes is in parallel.

Optionally, the first electrode layer is a continuous single layer over the planarization layer.

Optionally, the plurality of protrusions has a cross-section in a direction perpendicular to the base substrate, and the cross-section has one of a trapezoidal shape, a rectangular shape, a triangular shape, and an arcuate shape.

Optionally, a top surface of the plurality of protrusions and a top surface of the insulation layer are of substantially a same height from the base substrate. Optionally, a top surface of the portion of the first electrode layer over the protrusions and a top surface of the second electrode layer are of substantially a same height from the base substrate.

Optionally, a display panel is provided including the disclosed array substrate. Optionally, the display panel is a liquid crystal display panel having negative liquid crystals.

Another aspect of the present disclosure provides a method of fabricating an array substrate by providing a base substrate. A planarization layer is formed on the base substrate. The planarization layer includes a plurality of protrusions protruding away from the base substrate and resulting in a plurality of grooves between adjacent protrusions. A first electrode layer is formed on the planarization layer and has at least a portion over the plurality of protrusions of the planarization layer.

Optionally, an insulation layer is formed to at least partially fill each groove. A second electrode layer is formed over the insulation layer. Optionally, the protrusions and insulation layer are shaped such that the second electrode layer and the portion of the first electrode layer over the protrusions are of substantially a same height from the base substrate. Optionally, the second electrode layer includes a plurality of second sub-electrodes. Each second sub-electrode is in the groove between the adjacent protrusions and electrically insulated from the first electrode layer. The insulation layer is formed between the first electrode layer and the second electrode layer. Optionally, each second sub-electrode is stripe-shaped, and the plurality of second sub-electrodes is configured in parallel.

Optionally, the first electrode layer is a continuous single layer over the planarization layer. Optionally, the plurality of protrusions has a cross-section in a direction perpendicular to the base substrate, and the cross-section has one of a trapezoidal shape, a rectangular shape, a triangular shape, a circular shape, a curved shape, and an arcuate shape.

Optionally, a top surface of the plurality of protrusions and a top surface of the insulation layer are of substantially a same height from the base substrate. Optionally, a top surface of the portion of the first electrode layer over the protrusions and a top surface of the second electrode layer are of substantially a same height from the base substrate.

Optionally, a display panel is provided including the disclosed array substrate. Optionally, the display panel is a liquid crystal display panel having negative liquid crystals.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a cross sectional structure of a conventional array substrate;

FIG. 2 illustrates a cross sectional structure of an exemplary array substrate according to various embodiments of the present disclosure;

FIG. 3 illustrates simulation graphs of light transmittance versus driving voltage;

FIGS. 4a-4d illustrate cross sectional structures of an exemplary array substrate corresponding to certain stages of a fabricating process consistent with various embodiments of the present disclosure; and

FIG. 5 illustrates a flow chart of an exemplary method for fabricating an array substrate according to various embodiments of the present disclosure.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. It should be understood that the exemplary embodiments described herein are only intended to illustrate and explain the present invention and not to limit the invention.

The present disclosure provides an array substrate, a fabricating method and a display device directed to achieve high light transmittance at low power consumption.

FIG. 2 illustrates a cross sectional structure of an exemplary array substrate according to various embodiments of the present disclosure. As shown, the array substrate may include a planarization layer 12, a first electrode layer 13, an insulation layer 14, and a second electrode layer 15 sequentially formed on a base substrate 1.

The base substrate 1 may include a thin film transistor array (not shown). The second electrode layer 15 may include a plurality of second sub-electrodes 50 formed on the insulation layer 14. The planarization layer 12 may include a plurality of protrusions 20 protruded toward the second electrode layer 15. The protrusions 20 may protrude in a direction away from the base substrate 1, resulting in a plurality of grooves formed between adjacent protrusions. At least a portion of the first electrode layer 13 may be formed on the protrusions 20 of the planarization layer 12.

In one embodiment, the first electrode layer 13 may be a continuous single layer, conformally formed on the planarization layer 12. In another embodiment, the first electrode layer 13 may include a plurality of first sub-electrodes with each first sub-electrode at least partially on a corresponding protrusion 20.

Thus, the present disclosure provides an improved design for the planarization layer 12 on the base substrate 1. The planarization layer 12 is formed including the plurality of protrusions 20. In a direction (e.g., a vertical direction) perpendicular to a top surface of the base substrate 1, a distance between the portion of the first electrode layer 13 (or each first sub-electrode) formed on the protrusions 20 and the second sub-electrodes 50 may be reduced. As a result, the horizontal electric field intensity between the first electrode layer 13 and the second electrode layer 15 may be increased and the effective range of the vertical electric field may be narrowed. High display brightness may be achieved at a reduced driving voltage of the display panel.

Compared with existing technologies, at a same driving voltage, the array substrate provided by the present disclosure may have a smaller horizontal distance (e.g., along a surface of the base substrate 1) between the portion of the first electrode layer 13 formed on the protrusions 20 of the planarization layer 12 and the second sub-electrodes 50. This increases the horizontal electric field intensity and may more effectively drive the liquid crystal molecules to move (e.g., flip and/or rotate). In other words, the array substrate of the display panel provided by the present disclosure may require a smaller driving voltage to control degree of movement of the liquid crystal molecules and may reduce the power consumption of the display panel.

In one embodiment, the first electrode layer 13 may be used as a pixel electrode layer and the second electrode layer 15 may be used as a common electrode layer. In various embodiments, the first electrode layer 13 and the second electrode layer 15 may be interchangeable. In other words, the first electrode layer 13 may be used as the common electrode layer and the second electrode layer 15 may be used as the pixel electrode layer.

As shown in FIG. 2, the second electrode layer 15 may include a plurality of second sub-electrodes 50. Each second sub-electrode 15 is in the groove between adjacent protrusions and electrically insulated from the first electrode layer 13, and an insulation layer 14 is between the first electrode layer 13 and the second electrode layer 15. There are gaps between adjacent second sub-electrodes 50. The protrusions 20 may be within the gaps. The array substrate provided by the present disclosure may be suitable for the display panel containing either positive or negative liquid crystals.

As described above, when a driving voltage is applied, positive liquid crystal molecules tend to orient along or in parallel with the electric field direction. When the electric field is in a direction (e.g., vertical direction) perpendicular to a top surface of the base substrate, for example, in a center region of the second sub-electrode or in the middle of the gaps between adjacent second sub-electrodes, liquid crystal molecules will be in a direction perpendicular to the base substrate. The light transmittance in such regions is deteriorated and dark lines are shown. However, as disclosed herein, the protrusions 20 disposed in the gaps (e.g., disposed in a middle of each gap) may reduce the vertical distance between the first electrode layer 13 and the second sub-electrodes 50. Distribution of the electric field line 16 in the vertical direction may be reduced. In this case, less or no liquid crystal molecules are vertically oriented. The light transmittance in the middle of each gap between adjacent second sub-electrodes 50 may be significantly increased. Thus, the display brightness may be increased and the power consumption may be reduced.

On the other hand, using negative liquid crystals may be an effective way to increase light transmittance. When a driving voltage is applied, negative liquid crystals tend to be oriented in a direction perpendicular to the electric field direction. The orientation of the negative liquid crystals may be less or may not be affected by the vertical electric field. Thus, high resolution display products using negative liquid crystals may improve light transmittance by approximately 20% to 50%, for example. However, conventional negative liquid crystal display panel may require higher driving voltage (e.g., about 6 V to about 7 V) to operate at the maximum brightness. Such high driving voltage exceeds the maximum output voltage of typical driver chips (driver ICs). Even if the driver chips may provide a maximum driving voltage within their operational output voltage range, such driver chips will suffer serious reliability degradation. When the negative liquid crystals operate at the same driving voltage (e.g., about 4.5 V to 5 V) as for the positive liquid crystals, the light transmittance may only be improved by about 5% or less. When operated at the driving voltage intended for positive liquid crystals, display panel products with negative liquid crystals may have longer response time than those with positive liquid crystals. It is thus difficult to scale up the production of display panel products with negative liquid crystals in a mass production scale.

When the array substrates provided by the present disclosure are used in the display panel products, due to the shortened distance between the portion of the first electrode layer 13 formed on the protrusions 20 and the second sub-electrodes 50 of the second electrode layer 15, without increasing the driving voltage, the array substrates provided by the present disclosure may have a stronger electric field intensity between the first electrode layer 13 and the second electrode layer 15.

In other words, to maintain the desirable electric field intensity between the first electrode layer 13 and the second electrode layer 15, the array substrates provided by the present disclosure may only require a lower driving voltage. Therefore, the array substrates provided by the present disclosure reduce the driving voltage required for display panel products with negative liquid crystals and make possible the mass production of the display panel products with negative liquid crystals.

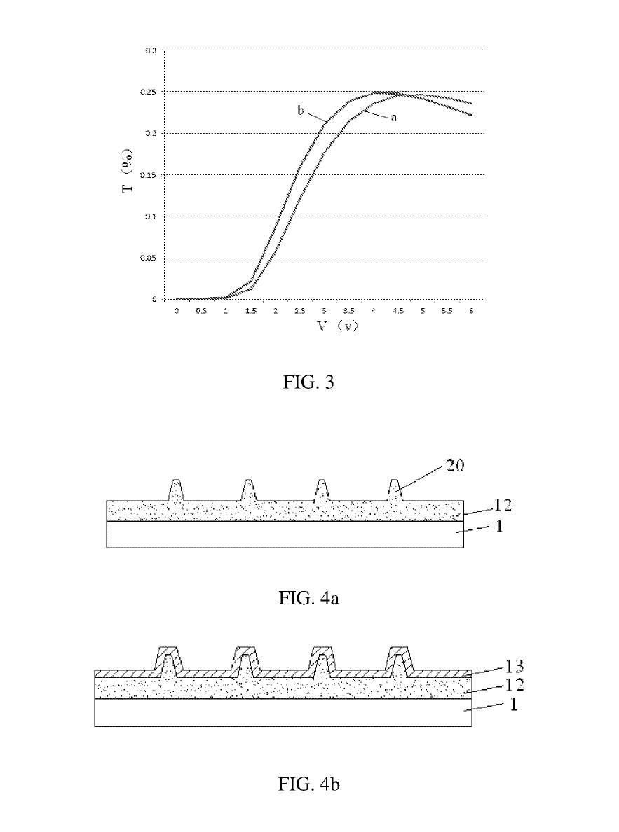

FIG. 3 illustrates simulation graphs of light transmittance versus driving voltage. As shown in FIG. 3, curve a corresponds to the simulation graph of light transmittance versus display panel driving voltage using the conventional method and curve b corresponds to the simulation graph of light transmittance versus display panel driving voltage using the disclosed method. In both cases, the liquid crystals used in the display panel products are positive liquid crystals.

As shown in FIG. 3, for a particularly light transmittance, curve b is shifted to the left of curve a by about 1 V. In the array substrate provided by the present disclosure, the driving voltage is reduced by about 1 V at the maximum brightness. That is, when positive liquid crystals are used in display panel products, only a driving voltage of about 4-5 V is required to achieve a shorter response time and maximum display brightness with low power consumption.

As disclosed herein, a height of the protrusions 20 is less than or equal to a total thickness including the insulation layer 14 and the second sub-electrodes 50. As shown in FIG. 2, the height of the portion of the first electrode layer 13 formed on the protrusions 20 may not exceed (e.g., be equal to) the height of the second sub-electrodes 50. In addition, each protrusion 20 may have a dimension less than a dimension of the gap between adjacent second sub-electrodes 50 in a same direction such as a direction along a surface of the base substrate. For example, a width of the protrusions 20 may be narrower than the width of the gaps between adjacent second sub-electrodes 50. Such dimensional configurations may be convenient for mass production of display panels, and may also provide structural stability for the display panels to avoid defects during the fabricating process.

The protrusions 20 extending from the bulk of the planarization layer 12 may have any suitable shapes. For example, in a vertical direction (and/or a horizontal direction) with respect to a top surface of the base substrate 1, the protrusion 20 may have a cross-section shape including a trapezoidal, rectangular, triangular, circular, and/or arcuate shape. For example, as shown in FIG. 2, the protrusion 20 may have a cross-section in a trapezoidal shape. In some embodiments, the protrusions 20 in a same array substrate may take multiple different shapes.

In various embodiments, the first and second sub-electrodes may also have any suitable shapes. For example, in a vertical direction (and/or a horizontal direction) with respect to a top surface of the base substrate 1, the first and second sub-electrodes may have a cross-section shape including a trapezoidal, rectangular, triangular, circular, curved, and/or arcuate shape.

In one certain embodiment, the first sub-electrodes may be stripe-shaped and may be configured parallel with one another. In another embodiment, the second sub-electrodes may be stripe-shaped and may be configured parallel with one another. In still another embodiment, the first and second sub-electrodes may be stripe-shaped and may be configured parallel with one another.

The present disclosure further provides a display panel, including the array substrates provided by the present disclosure. As shown in FIG. 2, the display panel further includes a counter substrate 8 disposed to face the base substrate 1, and the liquid crystals 7 filling up the space between the base substrate 1 and the counter substrate 8. However, in some embodiments, the display panel may not include any counter substrate. In various embodiments, the display panel further includes a protective layer.

In one embodiment, the counter substrate 8 may be a color film substrate configured with a color filtering film. The liquid crystals 7 may be positive or negative liquid crystals. As described above, the present disclosure reduces the driving voltage for the display panel products with negative liquid crystals. The display panel products with negative liquid crystals may have higher brightness when the same or a low driving voltage is applied. In the meantime, the response time may be reduced as well. The mass production of display panel products with negative liquid crystals may be realized. Therefore, the present disclosure is also suitable for producing high PPI display panel products with negative liquid crystals.

The present disclosure also provides a method of fabricating the array substrate and display panel. For example, a planarization layer having a plurality of protrusions is formed on a base substrate containing a thin film transistor array. A first electrode layer is formed on the planarization layer. An insulation layer is formed on the first electrode layer. A second electrode layer having a plurality of sub-electrodes is formed on the insulation layer. The protrusions are extended toward the second electrode layer and at least a portion of the first electrode layer is formed on the protrusions.

The present disclosure provides an improved design for the planarization layer including a plurality of protrusions. Along the direction perpendicular to the base substrate, the distance between the portion of the first electrode layer 13 formed on the protrusions 20 and the second sub-electrodes 50 is reduced. As a result, the horizontal electric field intensity between the first electrode layer 13 and the second electrode layer 15 is increased and the driving voltage for the display panel products is reduced to achieve high brightness display at the low power consumption. In other words, at the same driving voltage, the display panel products using the disclosed array substrates provide higher display brightness compared with conventional display panel products.

Further, gaps are formed between adjacent second sub-electrodes. The protrusions are disposed in the gaps. The protrusions are disposed in the gaps to reduce the vertical distance between the first electrode layer and the second electrode layer. The electric field line distribution in the vertical direction is reduced. Less or no liquid crystal molecules may be vertically oriented. When positive liquid crystals are used, the light transmittance in the center region of the second sub-electrodes and in the middle of the gaps between adjacent second sub-electrodes is increased. Thus, the display brightness is increased and the power consumption is reduced. When negative liquid crystals are used, the driving voltage is reduced to allow the mass production of the display panel products with negative liquid crystals.

In the present disclosure, a halftone mask is used to form a planarization layer having a plurality of protrusions. The patterns of the halftone mask are adjusted to control the shape and height of the protrusions of the planarization layer.

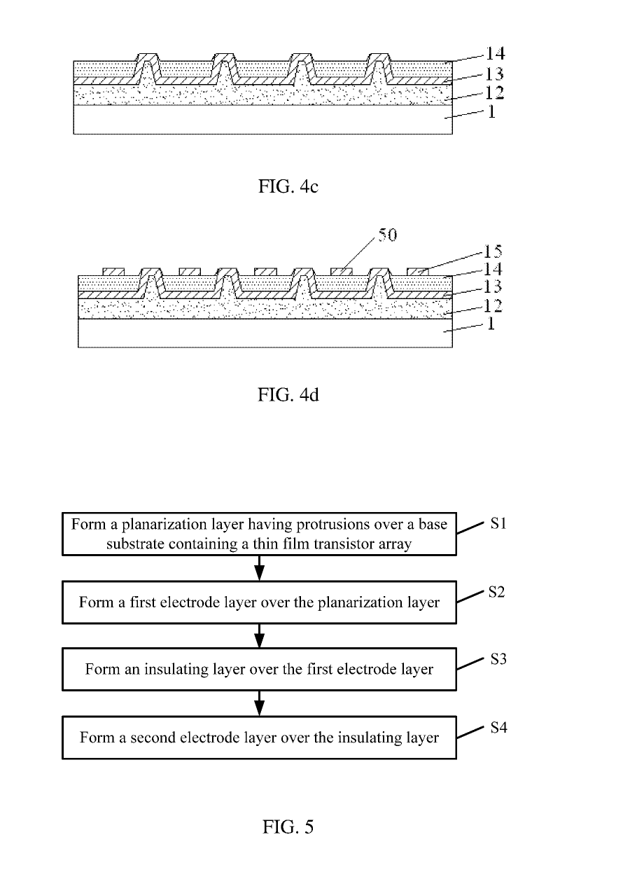

FIGS. 4a-4d illustrate cross sectional structures of an exemplary array substrate corresponding to certain stages of a fabricating process according to various embodiments of the present disclosure. FIG. 5 illustrates a flow chart of an exemplary method for fabricating the array substrate according to various embodiments of the present disclosure.

In Step S1 of FIG. 5 and referring to FIG. 4a, a halftone mask may be used to form a planarization layer 12 having a plurality of protrusions 20, on the base substrate 1 containing a thin film transistor array.

In Step S2 of FIG. 5 and referring to FIG. 4b, a first electrode layer 13 may be formed on the planarization layer 12. For example, to form the first electrode layer 13, the planarization layer 12 may be coated with a first electrode layer material. A photoresist layer may be formed on the first electrode layer material, and then be exposed and developed to form a photoresist mask layer. The photoresist mask layer may be used as an etch mask to etch the first electrode layer material to form the first electrode layer 13 at least having a portion on the planarization layer 12. The first electrode layer 13 may have a uniform thickness on the planarization layer 12. In one embodiment, the first electrode layer 13 may be used as a pixel electrode layer.

In Step S3 of FIG. 5 and referring to FIG. 4c, an insulation layer 14 may be formed on the first electrode layer 13. For example, to form the insulation layer 14, an insulation layer material may be vapor deposited on the structure shown in FIG. 4b. The insulation layer material may then be etched in a photolithography process to form insulation layer 14 on the first electrode layer 13. For example, the insulation layer 14 may have a top surface lower than a top surface of the protruded portions of the first electrode layer 13.

In Step S4 of FIG. 5 and referring to FIG. 4d, a second electrode layer 15 may be formed on the insulation layer 14. For example, to form the second electrode layer 15, a second electrode layer material may be coated on the insulation layer 14 and then be etched in a photolithography process to form the second electrode layer 15 having a plurality of second sub-electrodes 50 on the insulation layer 14 as shown in FIG. 4d. The second electrode layer 15 may be used as a common electrode layer.

An exemplary array substrate may thus be produced. Liquid crystals may be dropped on the produced array substrate. Frame sealant may be coated on the counter substrate (or color film substrate). The array substrate and the counter substrate can be aligned up with one another and then vacuum sealed or otherwise combined. After a cutting process, the combined array substrate and counter substrate may form individual display panels.

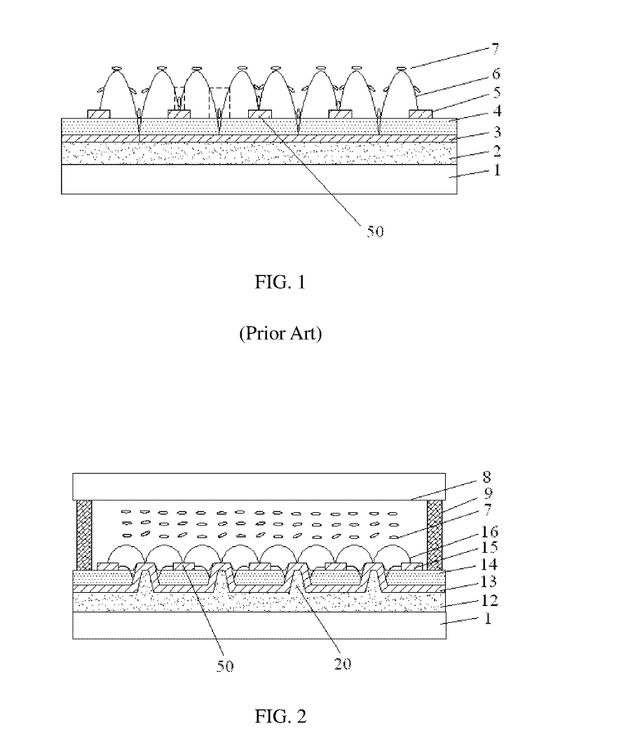

In the present disclosure, the planarization layer 12 may have protruded structures, i.e., protrusions 20. The height of the protrusions 20 from the bulk of the planarization layer 12 may be a total thickness for the insulation layer 14 and the second sub-electrodes 50. In various embodiments, a dimension (e.g., a width) of the protrusions 20 may be determined by the width of the dark line shown in FIG. 1.

The present disclosure effectively reduces the vertical distance between the top portion of the first electrode layer 13 formed on the protrusions 20 and the second sub-electrodes 50 of the second electrode layer 15, increases the electric field intensity there-between, reduces the driving voltage for the display panel, and achieves the low power consumption display. The present disclosure is suitable for display panels with negative liquid crystal to achieve high brightness display at a low driving voltage and allows the mass production of the display panel product with negative liquid crystals.

The embodiments disclosed herein are exemplary only. Other applications, advantages, alternations, modifications, or equivalents to the disclosed embodiments are obvious to those skilled in the art and are intended to be encompassed within the scope of the present disclosure.

1. An array substrate, comprising:
a base substrate;
a planarization layer on the base substrate, the planarization layer having a plurality of protrusions protruding away from the base substrate and resulting in a plurality of grooves between adjacent protrusions; and
a first electrode layer having at least a portion over the plurality of protrusions of the planarization layer.

2. The array substrate of claim 1, further comprising:
an insulation layer at least partially filling each groove, and
a second electrode layer over the insulation layer.

3. The array substrate of claim 2, wherein the protrusions and insulation layer are shaped such that the second electrode layer and the portion of the first electrode layer over the protrusions are of substantially a same height from the base substrate.

4. The array substrate of claim 3, wherein:
the second electrode layer comprises a plurality of second sub-electrodes,
each second sub-electrode is in the groove between the adjacent protrusions and electrically insulated from the first electrode layer, and
the insulation layer is between the first electrode layer and the second electrode layer.

5. The array substrate of claim 4, wherein each second sub-electrode is stripe-shaped, and the plurality of second sub-electrodes are in parallel.

6. The array substrate of claim 1, wherein the first electrode layer is a continuous single layer over the planarization layer.

7. (canceled)

8. The array substrate of claim 1, wherein:
the plurality of protrusions has a cross-section in a direction perpendicular to the base substrate, and
the cross-section has one of a trapezoidal shape, a rectangular shape, a triangular shape, a circular shape, a curved shape, and an arcuate shape.

9. The array substrate of claim 1, wherein a top surface of the plurality of protrusions and a top surface of the insulation layer are of substantially a same height from the base substrate.

10. The array substrate of claim 1, wherein a top surface of the portion of the first electrode layer over the protrusions and a top surface of the second electrode layer are of substantially a same height from the base substrate.

11. A display panel, comprising the array substrate of claim 1.

12. The display panel of claim 11, wherein the display panel is a liquid crystal display panel having negative liquid crystals.

13. A method of fabricating an array substrate, comprising:
providing a base substrate;
forming a planarization layer on the base substrate, the planarization layer including a plurality of protrusions protruding away from the base substrate and resulting in a plurality of grooves between adjacent protrusions; and
forming a first electrode layer on the planarization layer, wherein the first electrode layer has at least a portion over the plurality of protrusions of the planarization layer.

14. The method of claim 13, further comprising:
forming an insulation layer at least partially filling each groove, and
forming a second electrode layer over the insulation layer.

15. The method of claim 14, wherein the protrusions and insulation layer are shaped such that the second electrode layer and the portion of the first electrode layer over the protrusions are of substantially a same height from the base substrate.

16. The method of claim 15, wherein:
the second electrode layer comprises a plurality of second sub-electrode,
each second sub-electrode is in the groove between the adjacent protrusions and electrically insulated from the first electrode layer, and
the insulation layer is between the first electrode layer and the second electrode layer.

17. The method of claim 16, wherein each second sub-electrode is stripe-shaped, and the plurality of second sub-electrodes are in parallel.

18. (canceled)

19. The method of claim 13, wherein the first electrode layer is a continuous single layer over the planarization layer.

20. The method of claim 13, wherein:
the plurality of protrusions has a cross-section in a direction perpendicular to the base substrate, and
the cross-section has one of a trapezoidal shape, a rectangular shape, a triangular shape, a circular shape, a curved shape, and an arcuate shape.

21. The method of claim 13, wherein a top surface of the plurality of protrusions and a top surface of the insulation layer are of substantially a same height from the base substrate.

22. The method of claim 13, wherein a top surface of the portion of the first electrode layer over the protrusions and a top surface of the second electrode layer are of substantially a same height from the base substrate.
